(19) United States
(12) Patent Application Publication
(10) Pub. No.: US 2016/0239749 A1
(43) Pub. Date: Aug. 18, 2016

(54) USE OF OBJECT GROUP MODELS AND HIERARCHIES FOR OUTPUT PREDICTIONS

(71) Applicant: SAS INSTITUTE INC., Cary, NC (US)

(72) Inventors: Sergiy Peredriy, Chapel Hill, NC (US); Yung-Hsin Chien, Apex, NC (US); Arin Chaudhuri, Raleigh, NC (US); Ann Mary McGuirk, Raleigh, NC (US); Yongqiao Xiao, Cary, NC (US)

(73) Assignee: SAS INSTITUTE INC., Cary, NC (US)

(21) Appl. No.: 14/987,982

(22) Filed: Jan. 5, 2016

Related U.S. Application Data
(63) Continuation-in-part of application No. 12/259,676, filed on Oct. 28, 2008, now abandoned.

(51) Int. Cl. G06N 5/04; G06F 17/30

(52) U.S. Cl. CPC G06N 5/048; G06F 17/30592

(57) ABSTRACT

Computer-implemented systems and methods are provided for predicting outputs. Global output fractions associated with an object are approximated. Outputs for a group are predicted based upon a cyclical aspect component and a movement prediction. An output prediction is calculated based upon the predicted outputs for a related object group and the approximated global output fraction for a particular object.

### SUMMARY

In accordance with the teachings described herein, systems and methods are provided for using hierarchical data for predictions, such as data that are organized with respect to a spatial hierarchy and a category hierarchy. As an illustration, a computer-implemented system and method are provided herein for making output predictions based on the hierarchies. Fractions of a global output associated with a particular object may be approximated. Outputs for different groups may be predicted based upon a cyclical aspect component and a movement prediction. An object output prediction may be calculated based upon the predicted output for a group and the approximated fraction of the total output for that particular group.

As another illustration, past data may be received from a computer-readable data store. A cyclical aspect component may be approximated based upon aggregated data from a first level of the spatial hierarchy and a first level of the object hierarchy. A movement prediction may be predicted based upon aggregated data from a second level of the spatial hierarchy and a second level of the object hierarchy. The second level of the spatial hierarchy may be at an equal or more detailed level in the spatial hierarchy than the first level of the spatial hierarchy, or the second level of the object hierarchy may be at an equal or more detailed level in the object hierarchy than the first level of the object hierarchy. For an object within a related object group, a fraction of the global output may be approximated that is associated with the object with respect to other objects in the related object group. Predictions for a related object group may be based upon the cyclical aspect component and the movement prediction, where a related object group is a collection of related objects. For the object within a related object group, a prediction may be calculated based upon the prediction for a related object group and the approximated object fraction of global output. The calculated prediction may be stored in a computer-readable data store. The receiving, predicting, including cyclical aspect prediction and movement prediction, estimating a fraction of global output, and storing may all be performed on one more data processors.

As a further example, computer-implemented systems and methods for making predictions utilizing past data that is stored with respect to a spatial hierarchy and an object hierarchy may include a computer-readable data store for housing the past data. A cyclical aspect estimator may be configured to approximate a cyclical aspect (e.g., season-based or period-based) component based upon aggregate data from a first level of the spatial hierarchy and a first level of the object hierarchy. A movement predictor may be configured to make a movement prediction based upon aggregated data from a second level of the spatial hierarchy and a second level of the object hierarchy. The second level of the spatial hierarchy may be at an equal or more detailed level in the spatial hierarchy than the first level of the spatial hierarchy, or the second level of the object hierarchy may be at an equal or more detailed level in the object hierarchy than the first level of the object hierarchy. A fraction of global output estimator may be configured to approximate, for an object within a related object group, a global output fraction associated with the object with respect to other objects in the related object group. An output predictor may be configured to predict outputs for a related object group based upon the cyclical aspect component and the movement prediction, where a related object group is a collection of related objects or share group. An object output prediction calculator may be configured to calculate, for the object within a related object group, an object output prediction based upon the predicted outputs for a related object group and the approximated object fraction, and the calculated object output prediction may be stored in a computer-readable data store.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process performed by an event stream processing engine, according to some embodiments of the present technology.

FIG. 10 illustrates an ESP system interfacing between a publishing device and multiple event subscribing devices, according to embodiments of the present technology.

FIG. 11 is a block diagram depicting a computer-implemented environment for predicting outputs utilizing past data that is stored with respect to a spatial hierarchy and an object hierarchy.

FIG. 12 is a block diagram depicting an example spatial hierarchy.

FIG. 13 depicts an example object hierarchy and example contents of an object hierarchy.

FIG. 14 depicts an example related object group structure and example related object group contents.

FIG. 15 depicts example object fractions for a related object group.

FIG. 16 is a block diagram depicting an interaction model prediction system.

FIG. 17 is a block diagram depicting further details of a related object group predictor.

FIG. 18 is a block diagram of a prediction system and the levels used for making cyclical aspect approximates and movement predictions.

FIG. 19 depicts complementary related object groups.

FIG. 20 depicts competing related object groups.

FIG. 21 is a block diagram depicting the integration of secondary effects in the related object group model prediction system.

FIG. 22 depicts level selection for a cyclical aspect estimation.

FIG. 23 depicts level selection for cyclical aspect estimation.

FIG. 24 is a flow diagram illustrating calculation of output predictions utilizing hierarchical data.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

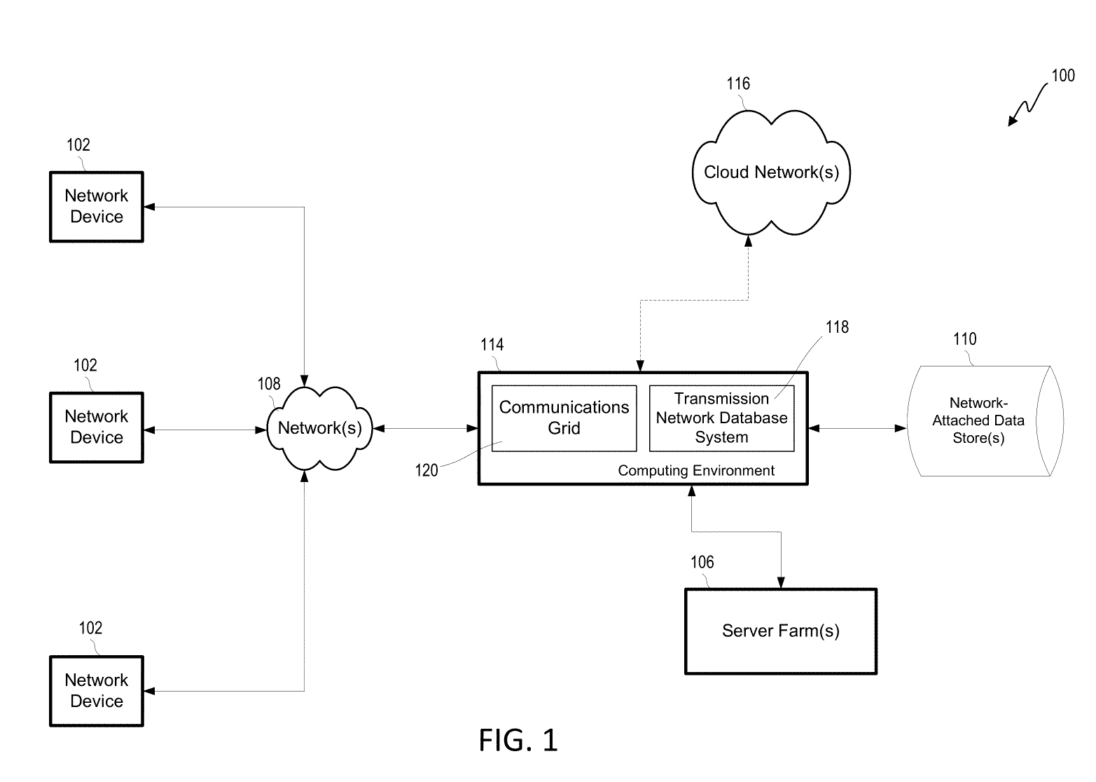

FIG. 1 is a block diagram that provides an illustration of the hardware components of a data transmission network 100, according to embodiments of the present technology. Data transmission network 100 is a specialized system that may be used for processing large amounts of data where a large number of processing cycles are required.

Data transmission network 100 may also include computing environment 114. Computing environment 114 may be a specialized or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

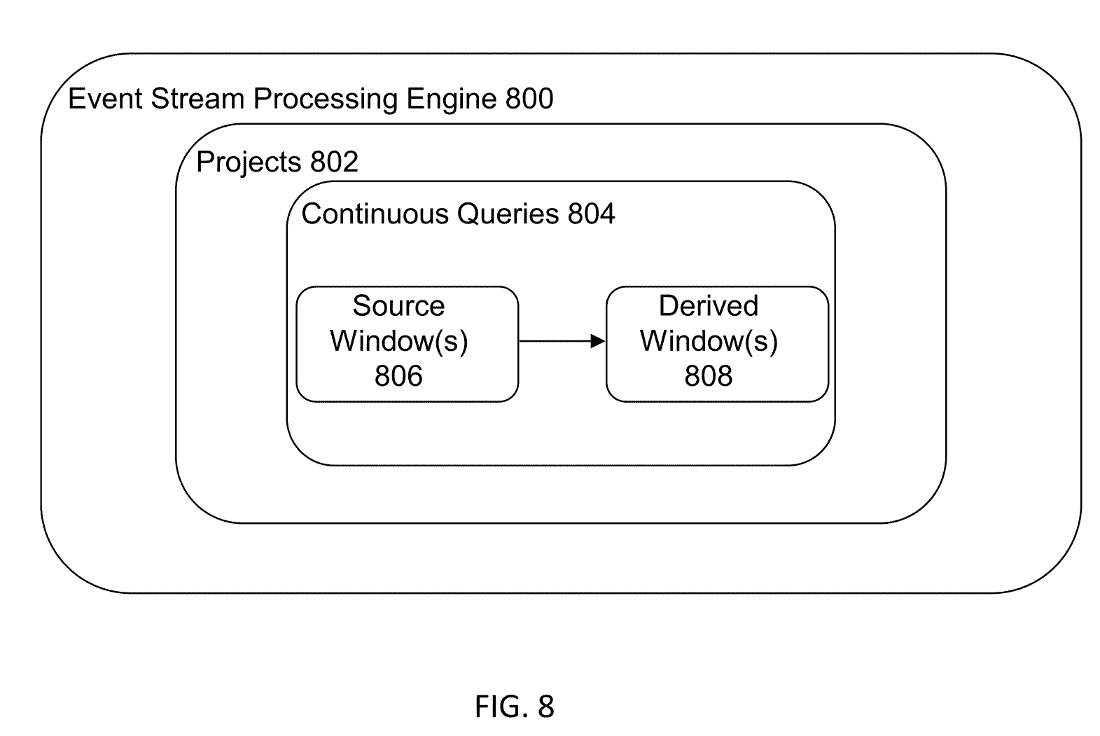

In other embodiments, network devices may provide a large amount of data, either all at once or streaming over an interval of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying objects being manufactured with parameter data for each object, such as colors and models) or object output databases (e.g., a database containing individual data records identifying details of individual object outputs/sales).

The unstructured data may be presented to the computing environment 114 in different forms such as a flat file or a conglomerate of data records, and may have data points and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time interval units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system as needed. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may comprise one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, as needed, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

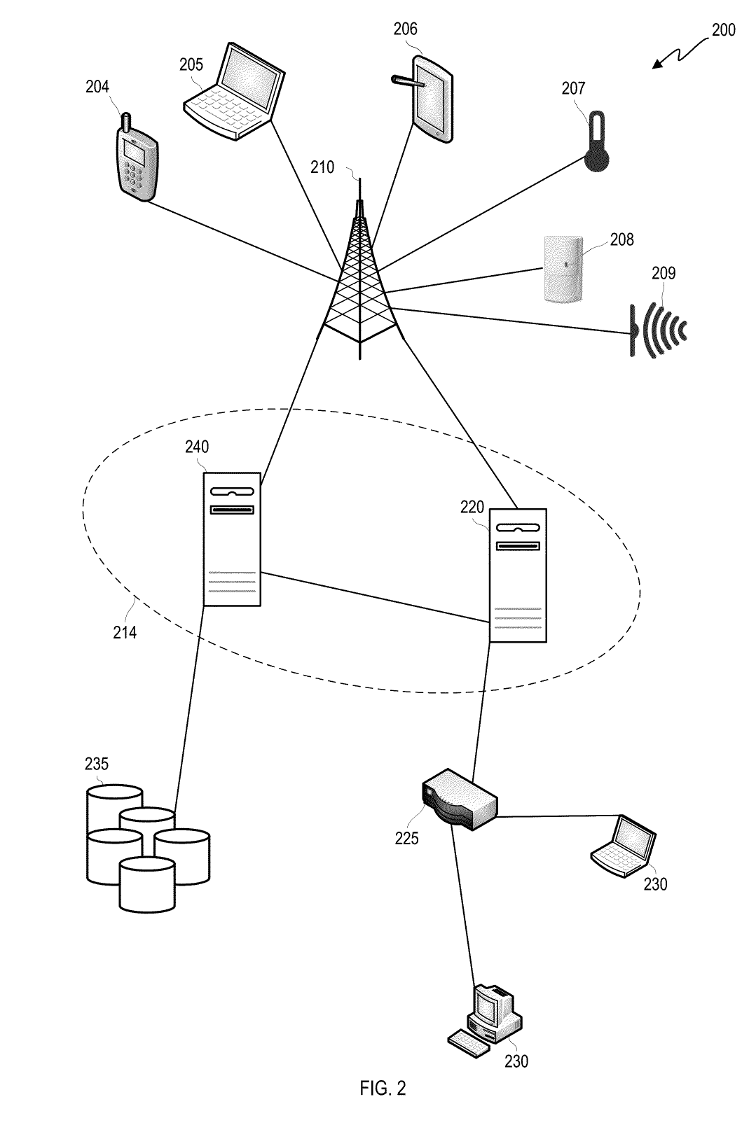

Each communication within data transmission network 100 (e.g., between client devices, between a device and connection system 150, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and relational analytics can be applied to identify hidden relationships and drive increased effectiveness. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, and homes, among others. One or more of such devices may include one or more sensors that detect energy gain or loss, electrical input or output or loss, and a variety of other benefits. These sensors may collect data to inform users of how the energy grid, and individual devices within the grid, may be functioning and how they may be better utilized.

Network device sensors may also process data collected before transmitting the data to the computing environment 114, or before deciding whether to transmit data to the computing environment 114. For example, network devices may determine whether data collected meets certain rules, for example by comparing data or points calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operation, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., object information, client rules, etc.), technical object details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over an interval of time for a client to determine results data based on the client's needs and rules.

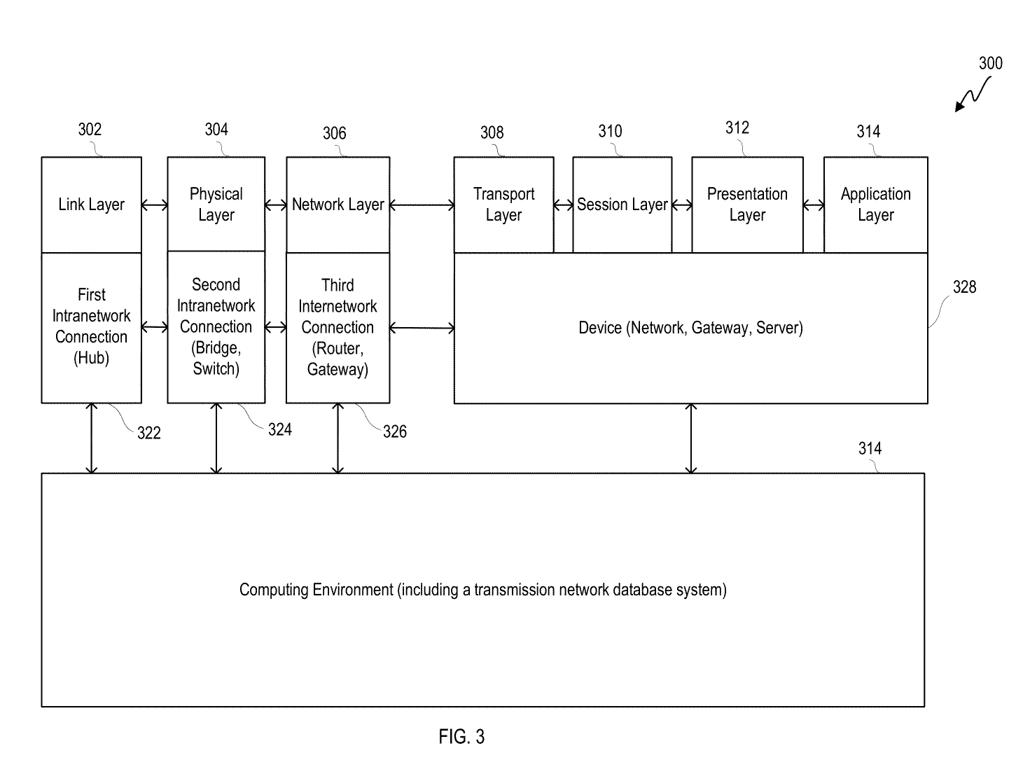

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 302-314. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with an application.

As noted, the model includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (i.e., move) data across a network. The link layer handles node-to-node communications, such as within a grid computing environment. Link layer 304 can detect and correct errors (e.g., transmission errors in the physical layer 302). Link layer 304 can also include a media access control (MAC) layer and logical link control (LLC) layer.

Network layer 306 defines the protocol for routing within a network. In other words, the network layer coordinates transferring data across nodes in a same network (e.g., such as a grid computing environment). Network layer 306 can also define the processes used to structure local addressing within the network.

Transport layer 308 can handle the transmission of data and the quality of the transmission and/or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and handle communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt and/or format data based on data types known to be accepted by an application or network layer.

Application layer 314 interacts directly with applications and end users, and handles communications between them. Application layer 314 can identify destinations, local resource states or availability and/or communication content or formatting using the applications.

Intra-network connection components 322 and 324 are shown to operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-314. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system (DBMS), controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

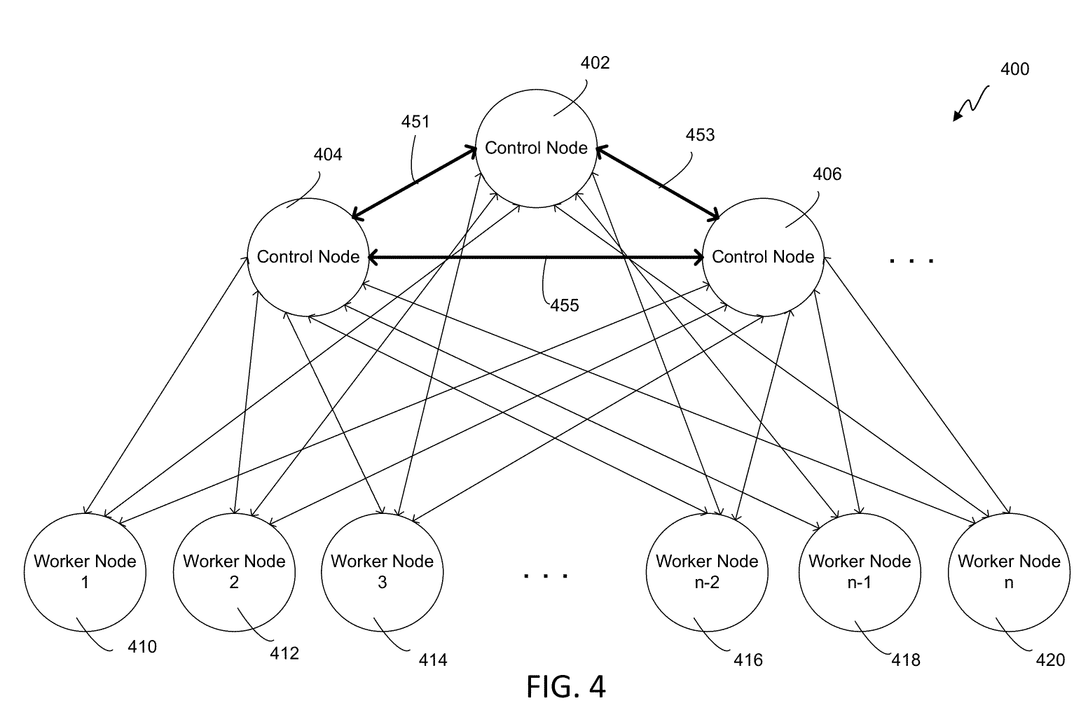

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be receive or stored by a machine other than a control node (e.g., a Hadoop data node).

Control nodes may maintain knowledge of the status of the nodes in the grid (i.e., grid status information), accept work requests from clients, subdivide the work across worker nodes, coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most effectively and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes). The primary control node may be provided with a list of other nodes (e.g., other machines, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined interval of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

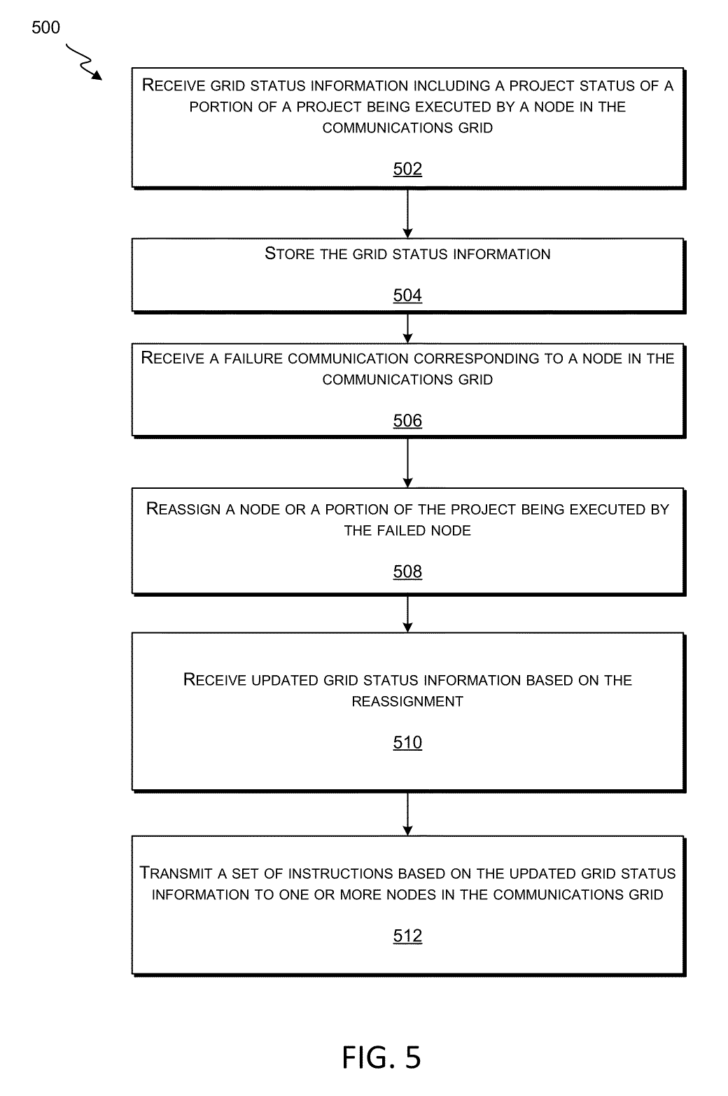

FIG. 5 illustrates a flow chart showing an example process for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

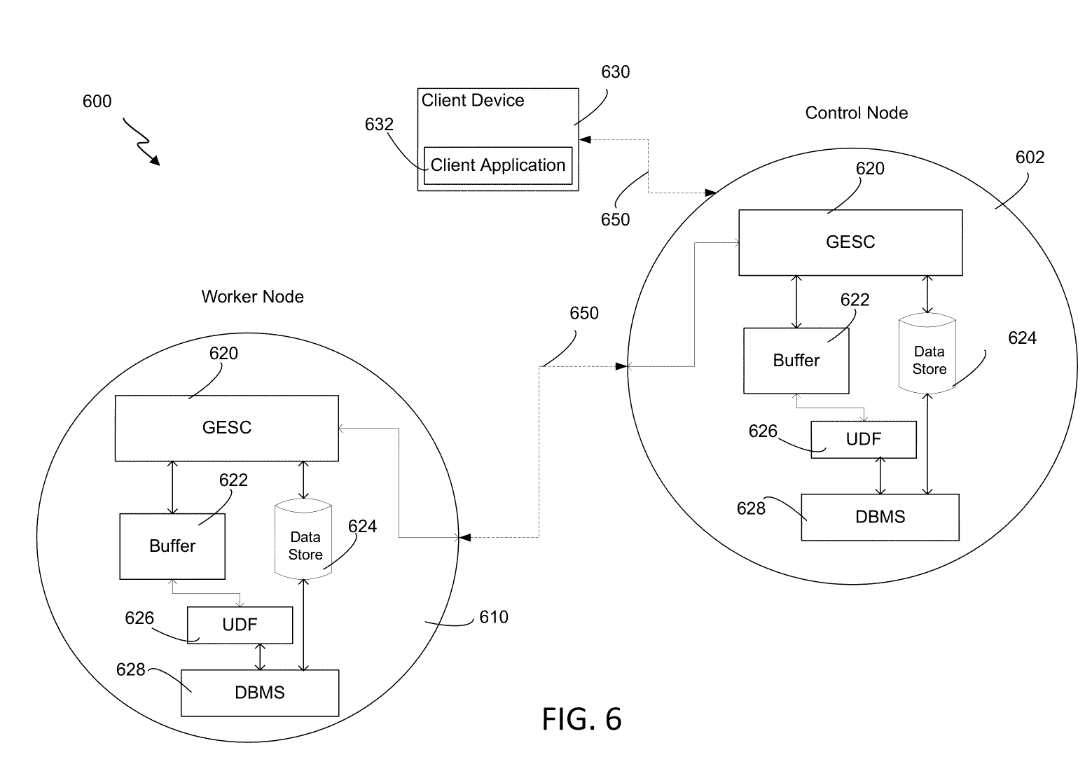

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a DBMS 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are handled by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) instructions. Each node may be capable of operating as either a control node or a worker node. The GESC at the control node 602 can communicate, over a communication path 652, with a client deice 630. More specifically, control node 602 may communicate with client application 632 hosted by the client device 630 to receive queries and to respond to those queries after processing large amounts of data.

DMBS 628 may control the creation, maintenance, and use of database or data structure (not shown) within a nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data handled in the associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

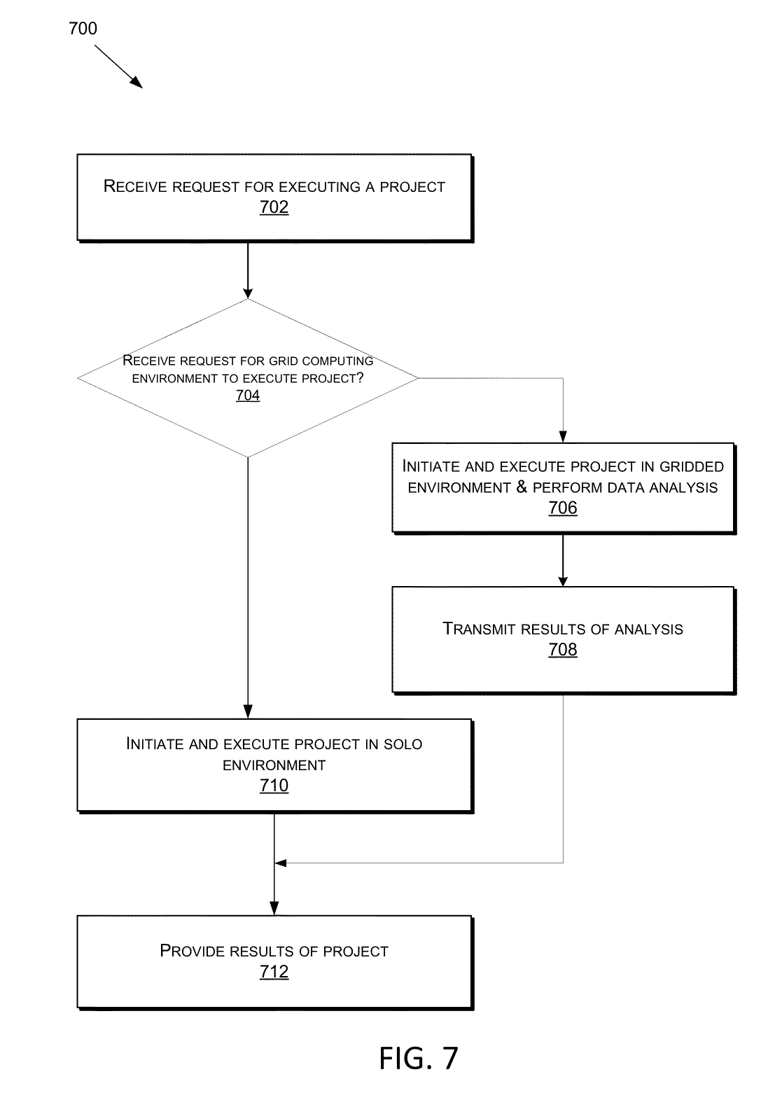

FIG. 7 illustrates a flow chart showing an example method for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

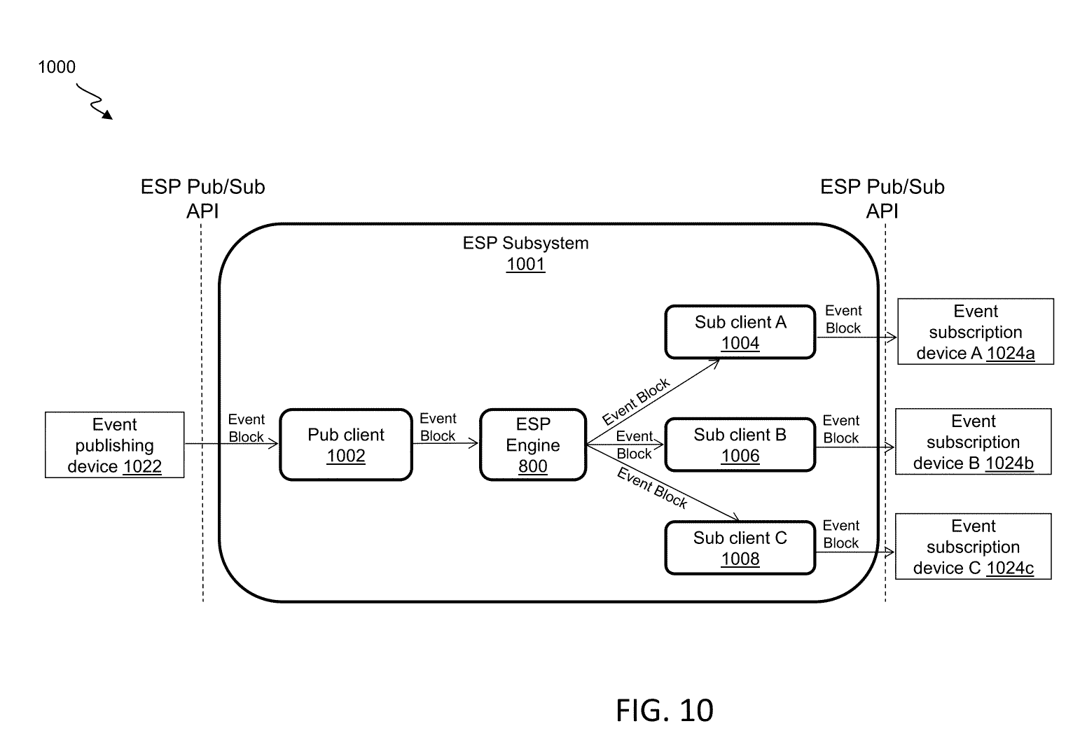

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model handled by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over an interval of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that handles the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other techniques on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, WL, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field data points and include both metadata and field data associated with an event. The metadata may include an opcode indicating if the event represents an insert, update, delete, or upsert, a set of flags indicating if the event is a normal, partial-update, or a retention generated event from retention policy handling, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

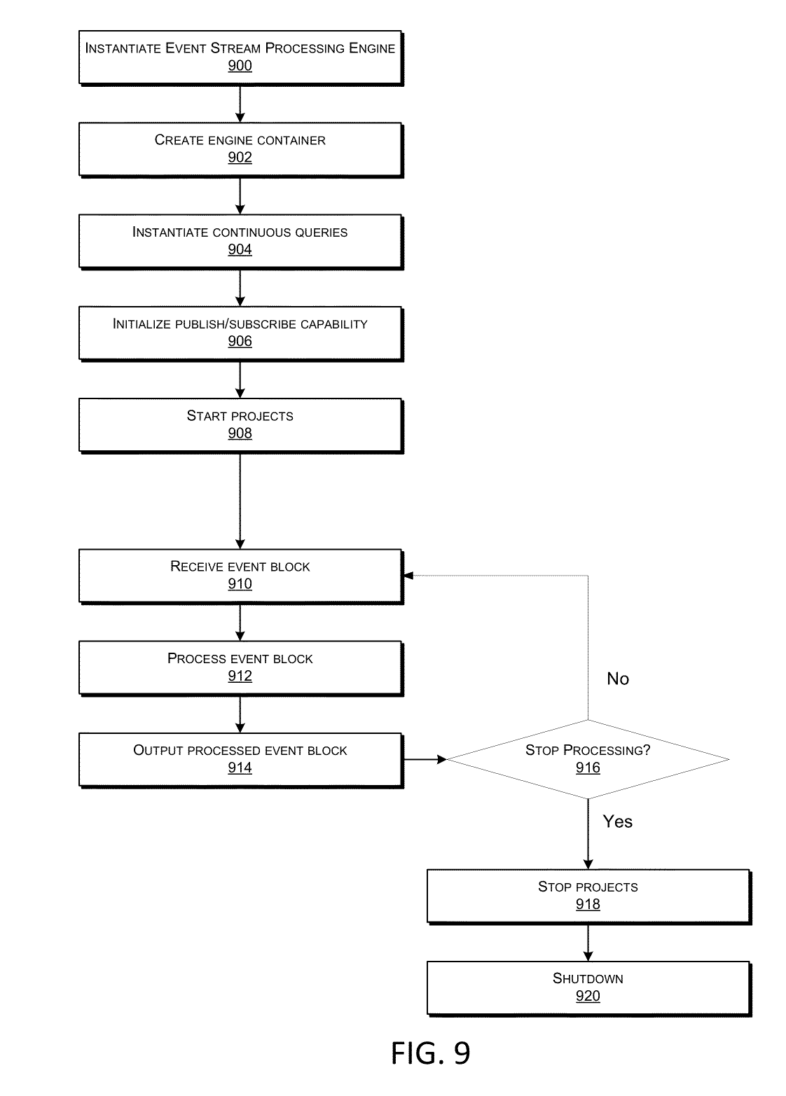

FIG. 9 illustrates a flow chart showing an example process of an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a handler for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and handling (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 1001, event publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a machine-readable medium operably coupled to the processor. The processor is configured to execute an ESP engine (ESPE). The machine-readable medium has instructions stored thereon that, when executed by the processor, cause the computing device to support the failover. An event block object is received from the ESPE that includes a unique identifier. A first status of the device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory machine-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory machine-readable medium.

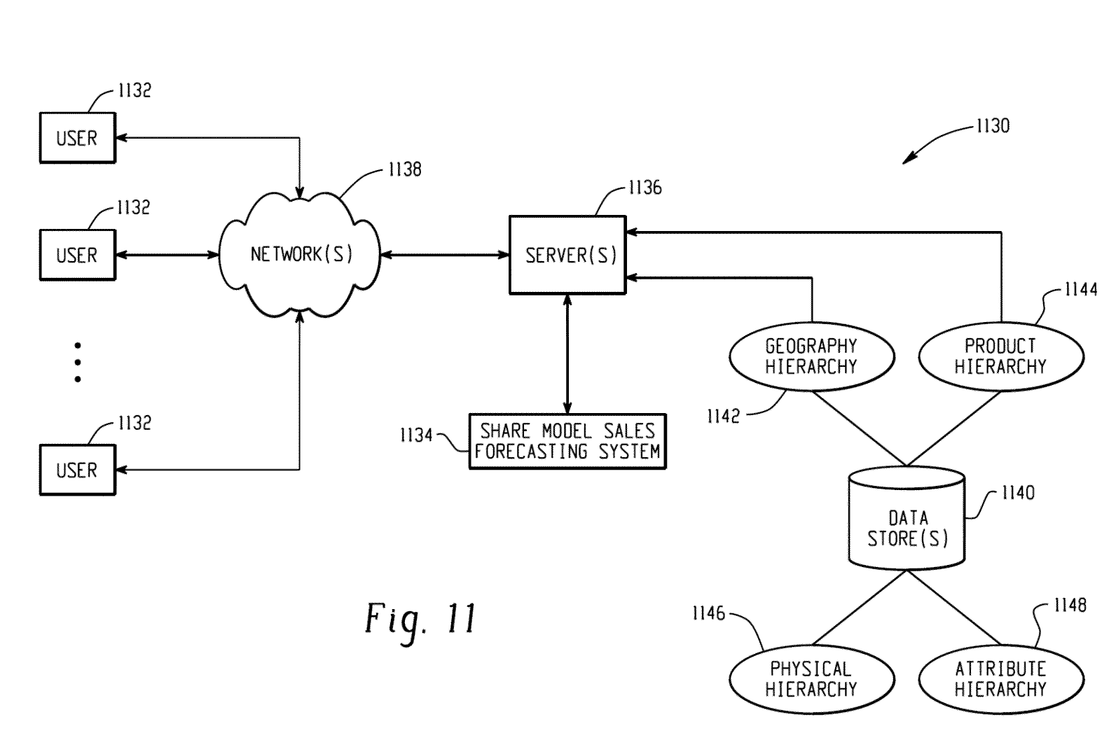

FIG. 11 is a block diagram illustrating an example prediction environment 1130. U.S. patent application Ser. No. 12/259,676, filed on Oct. 28, 2008, and hereby incorporated by reference in its entirety for all purposes, describes prediction systems and methods. The illustrated system 1130 may be useful for predicting outputs utilizing past data that is stored with respect to a spatial hierarchy and an object hierarchy. In FIG. 11, users 1132 can interact with an interaction model output prediction system 1134 hosted on one or more servers 1136 through a network 1138. The interaction model output prediction system 1134 computes predicted outputs using past data that is stored in one or more data stores 1140. The past data used by the interaction model output prediction system 1134 is organized with respect to a spatial hierarchy 1142 and an object hierarchy 1144.

The past data may be hierarchically stored within the one or more data stores 1140 in the spatial hierarchy 1142 and object hierarchy 1144 formats, or the spatial hierarchy 1142 and object hierarchy 1144 formats may be model hierarchies that are based upon one or more physical hierarchies 1146 and attribute hierarchies 1148 stored in the one or more data stores 1140. Generation of a model hierarchy based upon one or more physical and attribute hierarchies is described, for example, in application Ser. No. 12/241,784, filed Sep. 30, 2008, which is herein incorporated in its entirety by reference for all purposes.

An interaction model may be used in commercial applications to capture how the outputs of a group of objects interact with each other. The interaction model output prediction system 1134 models the effect of primary requirement drivers, such as cyclical aspects and movements (i.e., trends), using an interaction model within a hierarchical setting. This system 1134 enables users 1132 to approximate the primary requirement drivers at different levels in the object and spatial hierarchies, enabling users 1132 to capture the effects of the primary requirement drivers at points in the hierarchy where data provides the richest information. In addition, the system 1134 enables users 1132 to model secondary requirement effects which occur across related object groups, such as output reduction effects and/or bias effects across interacting related object groups.

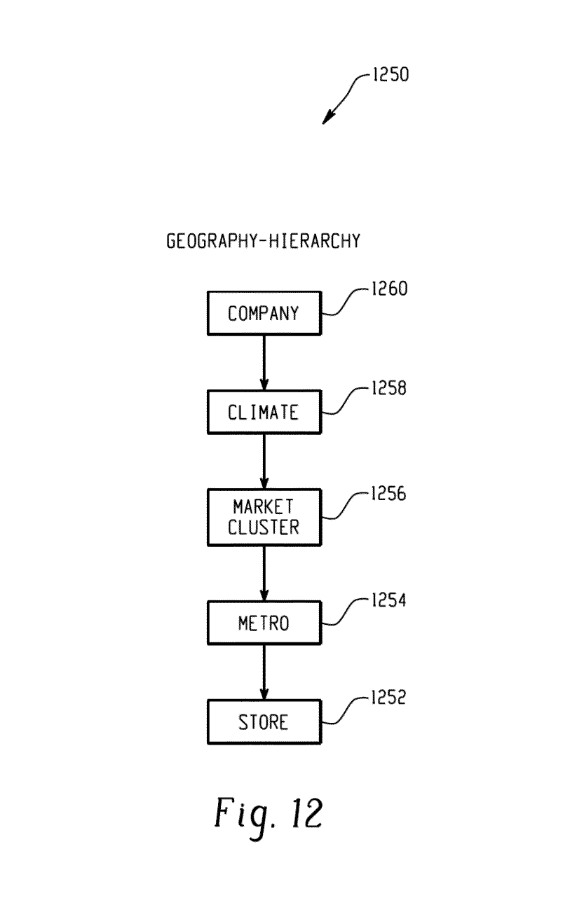

FIG. 12 is a block diagram depicting an example spatial hierarchy. The example spatial hierarchy 1250 contains five levels, with the store level 1252 being the lowest and most detailed level. Each member of the store level 1252 has a parent member in the metro level 1254. Each member of the metro level 1254 contains aggregate data based on the lower level members which are contained within the member of the metro level 1254. For example, the ‘Dallas’ node in the metro level may contain aggregate output data for all stores within the Dallas metro area, which reside on the store level. Similarly, parent-child relationships and associated aggregate data run to the cluster level 1256 from the metro level 1254; to the climate level 1258 from the cluster level 1256; and to the company level 1260 from the climate level 1258.

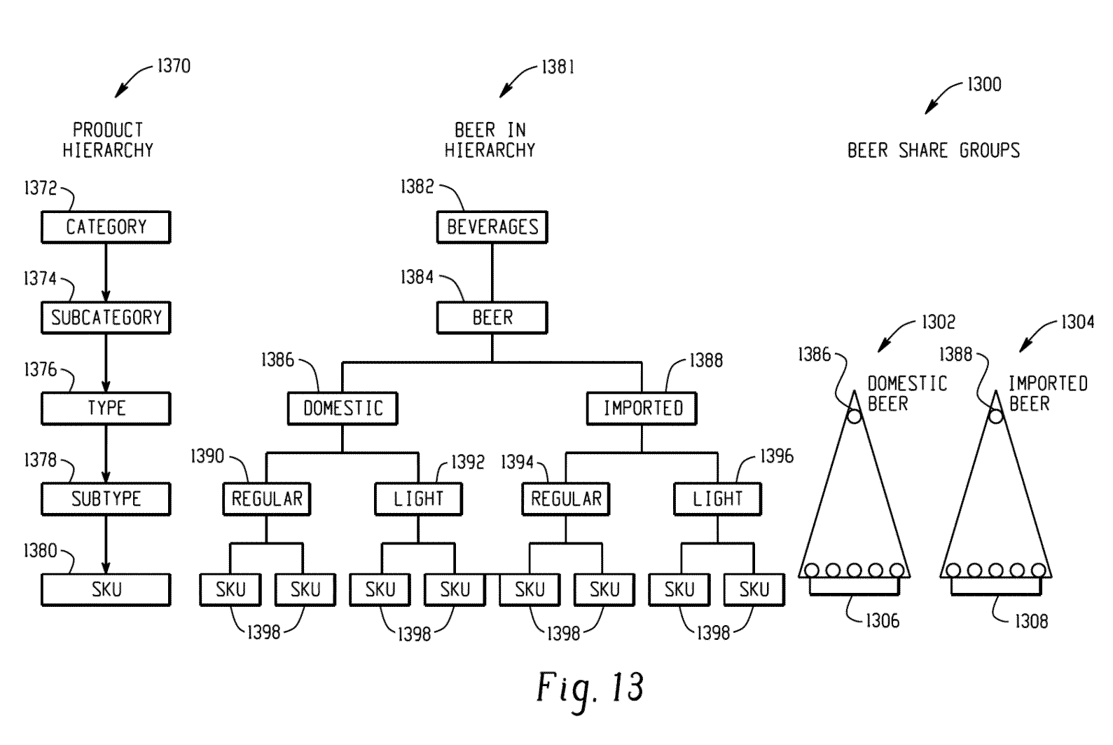

FIG. 13 depicts an example object hierarchy and example contents of an object hierarchy. The example object hierarchy 1370 contains five levels. The highest level, the category level 1372, contains the subcategory level 1374, which contains the type level 1376. The type level 1376 contains the subtype level 1378, which contains the lowest and most detailed level, the SKU (stock keeping unit) level 1380. The hierarchy 1381 illustrates example contents for each of the levels of the object hierarchy 1370. The category of the hierarchy that contains beer is beverages 1382, with 1384 being the subcategory. The subcategory 1384 is broken into two types, first (domestic) 1386 and second (import) 1388. Each of the types is broken down into subtype branches, regular 1390, 1394 and light 1392, 1396. Each of the subtypes contains one or more members 1398 at the SKU level.

A related object group is a collection of objects that compete against one another. The members of a related object group contend in that a choice from among the objects in the group tends to be made. A related object group may also be termed a choice set, which is a set of objects from which a choice is made. In a hierarchy perspective, the related object group may be thought of as a parent node and its child nodes, where the child nodes are all objects that contend with one another. For example, those looking for a soft drink are typically choosing from among all the objects with sugar (regular soft drink) or among all of the objects without sugar (diet soft drink). Because objects tend to be chosen from within one of these groups that meets their sugar/no sugar needs, the object level that splits regular soft drink from diet soft drink forms a good level for defining a related object group.

FIG. 13 illustrates two beer related object groups at 1300. The related object groups have been chosen at the type level such that the first (domestic) beer node 1386 heads first beer related object group 1302 and the second (import) beer node 1388 heads the second beer related object group. The lower level nodes 1306 of the first beer related object group 1302 that contend with one another are the members of the first beer related object group 1302. Similarly, the lower level nodes 108 of the second beer related object group 1304 that contend with one another are the members of the second beer related object group 1304.

It should be noted that the level definitions of related object groups and related object group members may be altered based upon prior gathered data and analysis needs. For example, if it is determined that beers tend to be selected based on the subtype rather than the type level, then related object groups may be selected at the subtype level. In the example of FIG. 13, this would result in four related object groups: first regular, first light, second regular, and second light. The level at which related object group members are selected may also differ depending on application. For example, it may be necessary to determine total requirement for regular and light beers without concern for individual SKUs. In this application, the related object groups would be defined at the type level and the member nodes would be defined at the subtype level.

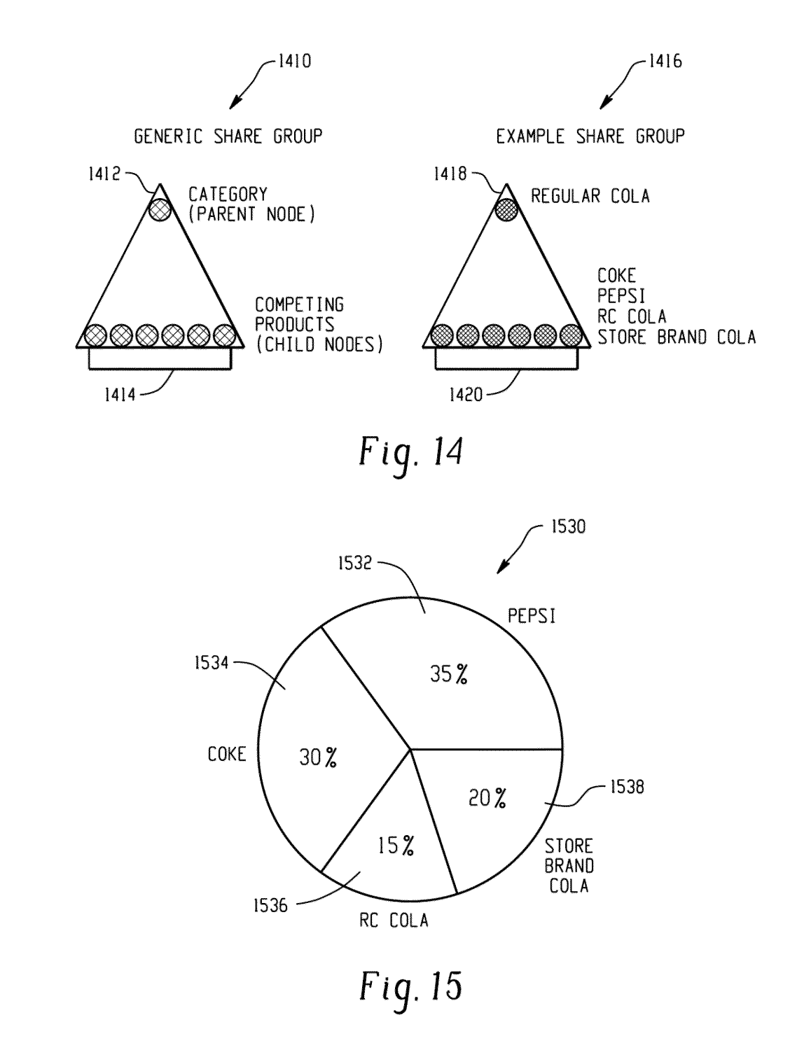

FIG. 14 depicts an example related object group structure and example related object group contents. As described above and shown in the generic related object group 1410, a related object group is made up of a parent node 1412 that defines the category and a plurality of child nodes 1414 that include a plurality of objects hierarchically subordinate to the parent node 1412 that compete among one another. An example related object group is shown at 1416 that is defined by the regular cola parent node 1418. A plurality of child nodes 1420 define the members of the regular cola related object group that include Coke, Pepsi, RC Cola, and Store Brand Cola.

The related object group is defined by the object hierarchy. The spatial hierarchy serves as the aggregation dimension, such that the related object group prediction model and the global output fraction model may be calibrated at a higher aggregation level to improve the quality and robustness of the model parameter approximates.

The interaction model, described above, captures how the outputs of a group of objects interact with each other. The interaction model may be used to generate predicted requirement for a particular related object group. While this predicted requirement is useful in some respects, it does not include a prediction for individual members within a related object group.

The object share or object fraction is a prediction of the relative amount, which may be expressed as a percentage, of each object in a related object group that will be output. The fractions for all objects in a related object group whose fractions are expressed as a percentage are equal to 100% or an equivalent (e.g., total fractions are equal to 1 if individual fractions are expressed as a ratio of individual portion to total such that individual fractions fall between 0 and 1). The object fraction is relative. This is in contrast to the related object group total requirement, which is absolute. Thus, the object fraction does not indicate scale. Object A with a 30% object fraction could account for 3 units output or 3000 units output, depending on the related object group total requirement.

FIG. 15 depicts example object fractions for a related object group. The pie chart 1530 of FIG. 15 illustrates example individual object fractions 1532, 1534, 1536, and 1538. The object fractions represent an individual object's fraction of the total regular cola related object group. The individual fractions are relative to the total related object group. Thus, the total of all object fractions within the related object group equals 100%. As noted above, actual predicted requirement or output cannot be gleaned from the object fractions depicted in FIG. 15. These object fractions are be combined with a related object group predicted requirement or related object group predicted output to generate absolute predicted requirement or outputs.

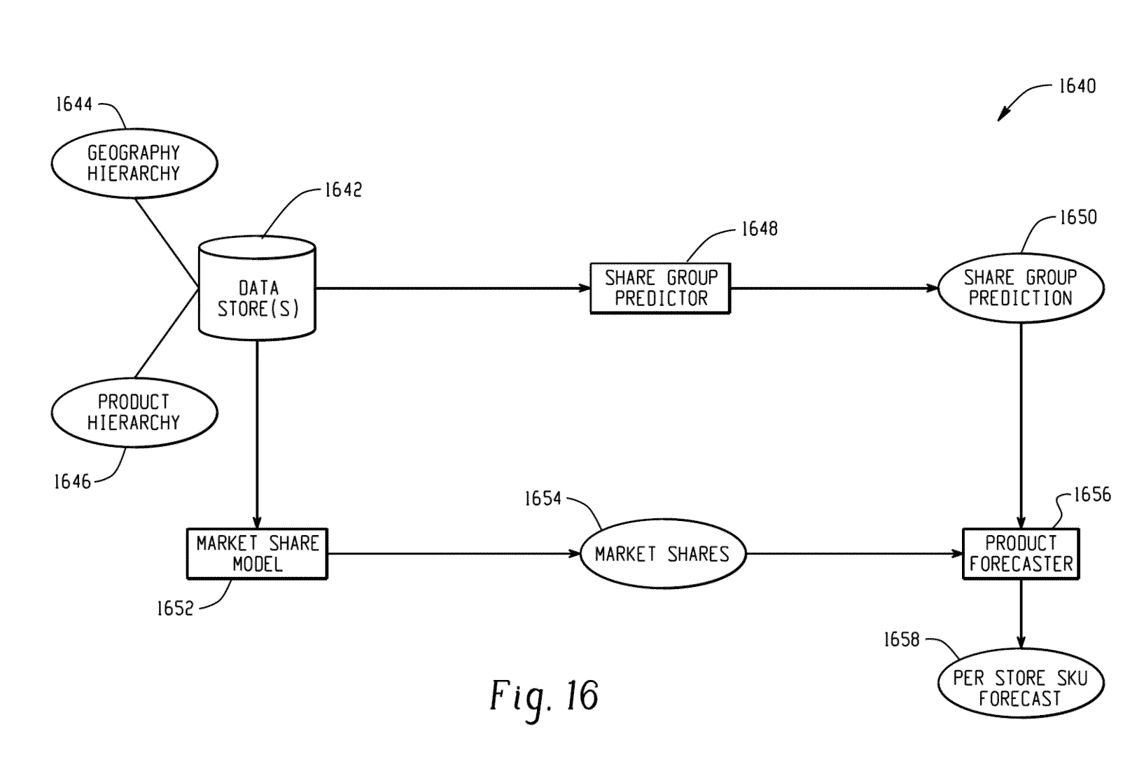

FIG. 16 is a block diagram depicting an interaction model output prediction system 1640. Past data is retained in the one or more data stores 1642. As noted above, this past data may be stored in the spatial hierarchy 1644 and object hierarchy 1646 formats within the data store 1642, or the spatial hierarchy 1644 and object hierarchy 1646 may be model hierarchies generated for use in the interaction model output prediction system 1640. The interaction model output prediction system 1640 executes over two branches that may be processed sequentially or in parallel. The first branch includes a related object group predictor 1648, which receives the spatial hierarchy 1644 and object hierarchy 1646 data and uses the received data to generate an output prediction (e.g., sales-prediction) or requirement prediction (e.g., demand-prediction) 1650 for an entire related object group. For example, the related object group predictor 148 may predict the requirement for the regular cola related object group at 100,000 units for the Dallas area for July.

The second branch of the interaction model output prediction system 1640 includes a global output fraction model 1652. The size of the fraction of each object is a measure of the object's attraction, which can be modeled as a function of object attributes, such as object/object class devotion, the object's charge and publicity, and other objects' charges and publicity. The global output fraction interaction model may be implemented as a mixed regression model that incorporates object attributes and publicity mix with past data, such as historical object data, from the spatial hierarchy 1644 and object hierarchy 1646 to generate individual global output fractions 1654 for the members of the related object group. For example, the global output fraction model 1652 may generate global output fractions 1654 such as those depicted in and discussed with reference to FIG. 15 for the regular cola related object group.

The generated related object group prediction 1650 and global output fractions 1654 are received by a predictor 1656. The predictor 1656 calculates individual absolute requirement or output predictions by multiplying the predicted requirement or output for the entire related object group by one or more of the individual global output fractions. The calculated absolute amounts are output, for example, as a per store SKU prediction 1658. As noted above, the use of the hierarchical structures of the spatial and object hierarchies enables definition of related object groups and related object group members at various levels of the hierarchies enabling predictions to be made at different levels depending on the application and data sufficiency.

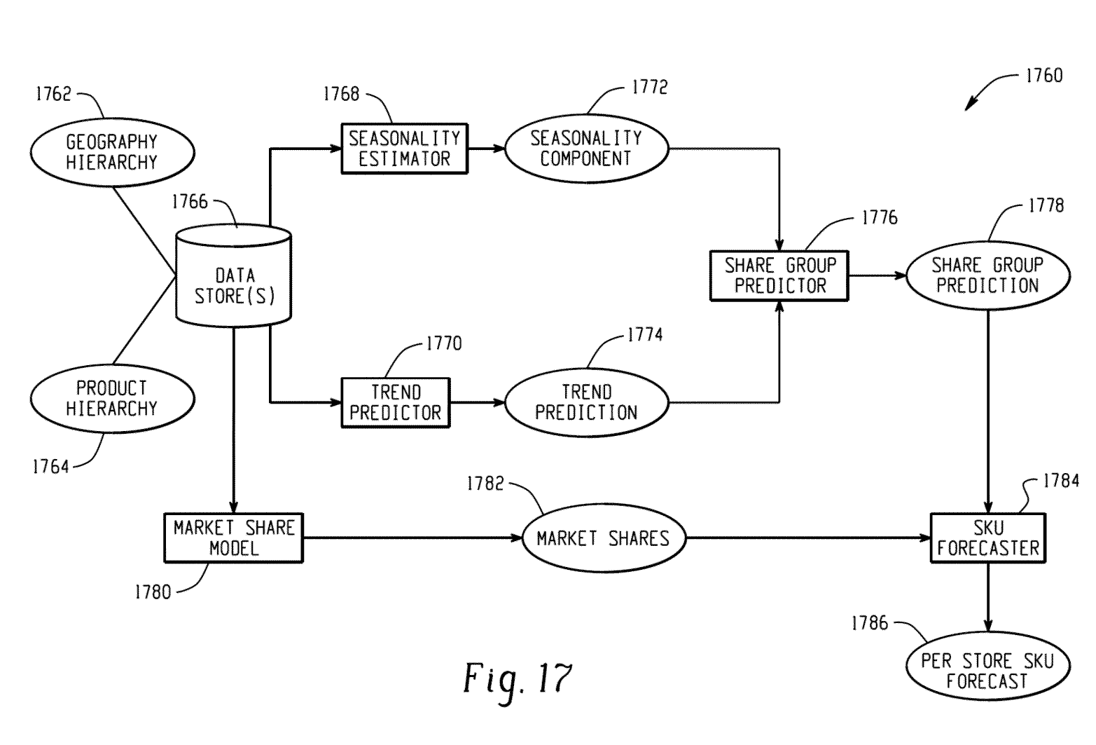

FIG. 17 is a block diagram depicting further details of a related object group predictor. The related object group predictor shown in FIG. 16 is broken down into example component parts in FIG. 17. In the example of FIG. 17, the spatial hierarchy 1762 and object hierarchy 1764 are received from the one or more data stores 1766, as previously described, by a cyclical aspect estimator 1768 and a movement predictor 1770. The cyclical aspect estimator 1768 and movement predictor 1770 generate a cyclical aspect component 1772 and a movement prediction 1774, respectively, that represent two of the primary requirement drivers for a related object group. The approximated cyclical aspect component 1772 and the movement prediction 1774 are received by the related object group predictor 1776, which utilizes the received cyclical aspect component 1772 and movement prediction 1774 to generate a related object group prediction 1778 that may identify predicted baseline output or requirement for an entire related object group.

As was described with respect to FIG. 16, the global output fraction model 1780 receives past data, attribute data, and other data from the one or more data stores 1766 and uses the received data in generating individual global output fractions 1782 for each of the members of the related object group at issue. An SKU predictor 1784 receives the related object group prediction 1778 and the individual global output fractions 1782 and determines a Per Store SKU prediction 1786 by multiplying the individual global output fractions 1782 by the prediction for the entire related object group 1778.

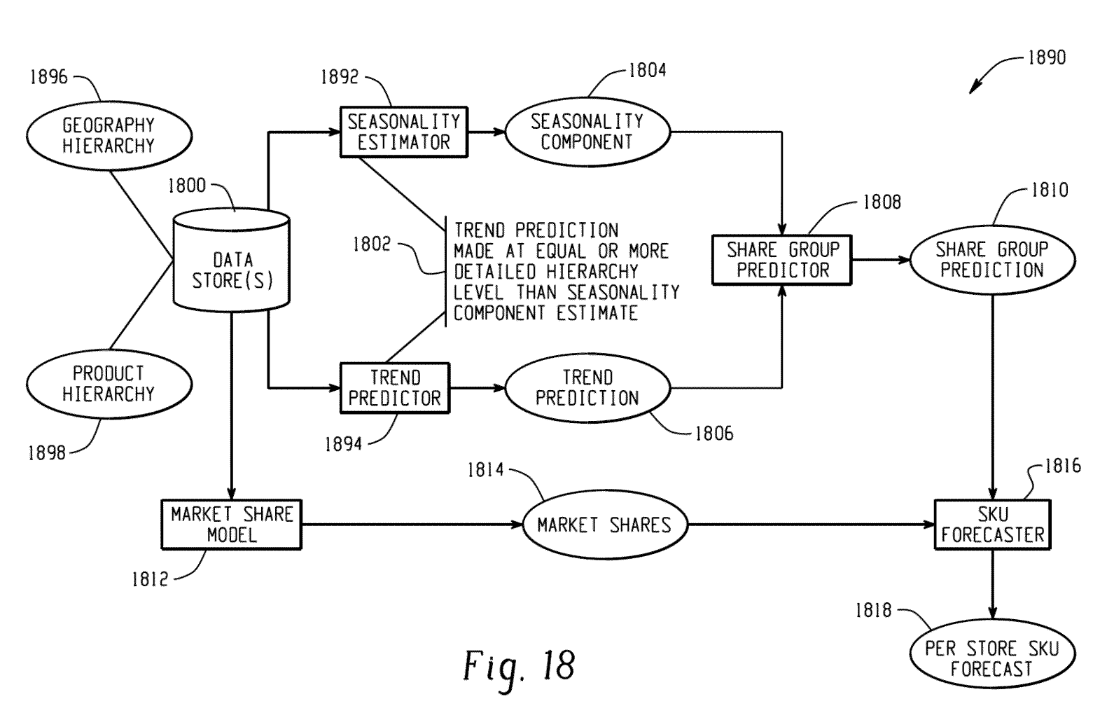

FIG. 18 is a block diagram of a model output prediction system and the levels used for cyclical aspect approximates and movement predictions. A cyclical aspect estimator 1892 and a movement predictor 1894 both receive spatial hierarchy 1896 and object hierarchy 1898 data from one or more data stores 1800. The cyclical aspect estimator 1892 and the movement predictor 1894 use the received hierarchies to generate a cyclical aspect component 1804 and a movement prediction 1806, respectively. The system of FIG. 18 notes at 1802 that the movement prediction is made at an equal or more detailed hierarchy level than the cyclical aspect component approximate. Thus, the cyclical aspect component is approximated at an equal or higher hierarchy level. For example, cyclical aspects may be approximated at an object subcategory level while movements may be predicted at a type level.

The benefits of predicting cyclical aspects at a higher level can be visualized with reference to the example beer hierarchy, illustrated in FIG. 13. For example, cyclical aspects for the beer hierarchy might be approximated at the subcategory level. This makes sense because beer may do better in the summer when it is hotter and less in the winter when it is cool. However, movements may be predicted on the type level. For example, as economics improve, more costly (e.g., import) beers may move/trend towards being more popular.

The cyclical aspect component 1804 and the movement prediction 1806 are received by the related object group predictor 1808. The related object group predictor utilizes the received cyclical aspect component 1804 and movement prediction 1806 to calculate a prediction 1810 for the entire related object group, such as predicted requirement or predicted outputs. The global output fraction model 1812 receives past data, attribute data, and other data from the one or more data stores 1800 and uses the received data in generating individual global output fractions 1814 for each of the members of the related object group at issue. An SKU predictor 1816 receives the related object group prediction 1810 and the individual global output fractions 1814 and determines a Per Store SKU prediction 1818 by multiplying the individual global output fractions 1814 by the prediction for the entire related object group 1810.

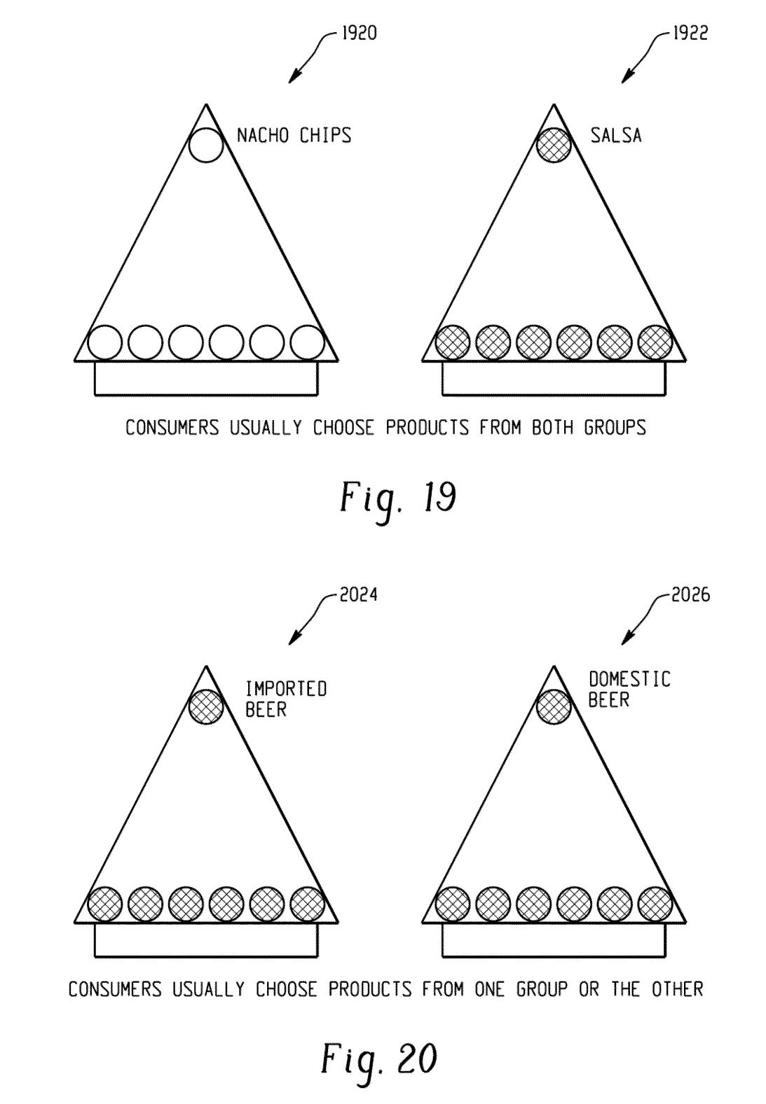

The interaction model may also incorporate secondary effects caused by interacting related object groups. Interacting related object groups are related object groups that interact with each other so that outputs in one related object group increase or decrease based on another related object group's charges and publicity. FIG. 19 depicts complementary related object groups, where charge and publicity of members of the nacho chips related object group 1920 may have a positive effect on output in both the nacho chips related object group 1920 and the salsa related object group 1922 because objects from both groups may usually be chosen together. This positive effect on complementary related object groups is known as a halo or bias effect. FIG. 20 depicts comparable related object groups, where charge and publicity of members of the second beer group 2024 may have a negative effect on output in the first beer group 2026 because the second beer group 2024 and the first beer group 2026 may compete when the difference in charges between the groups becomes small. This detrimental effect between comparable related object groups is known as an output reduction effect.

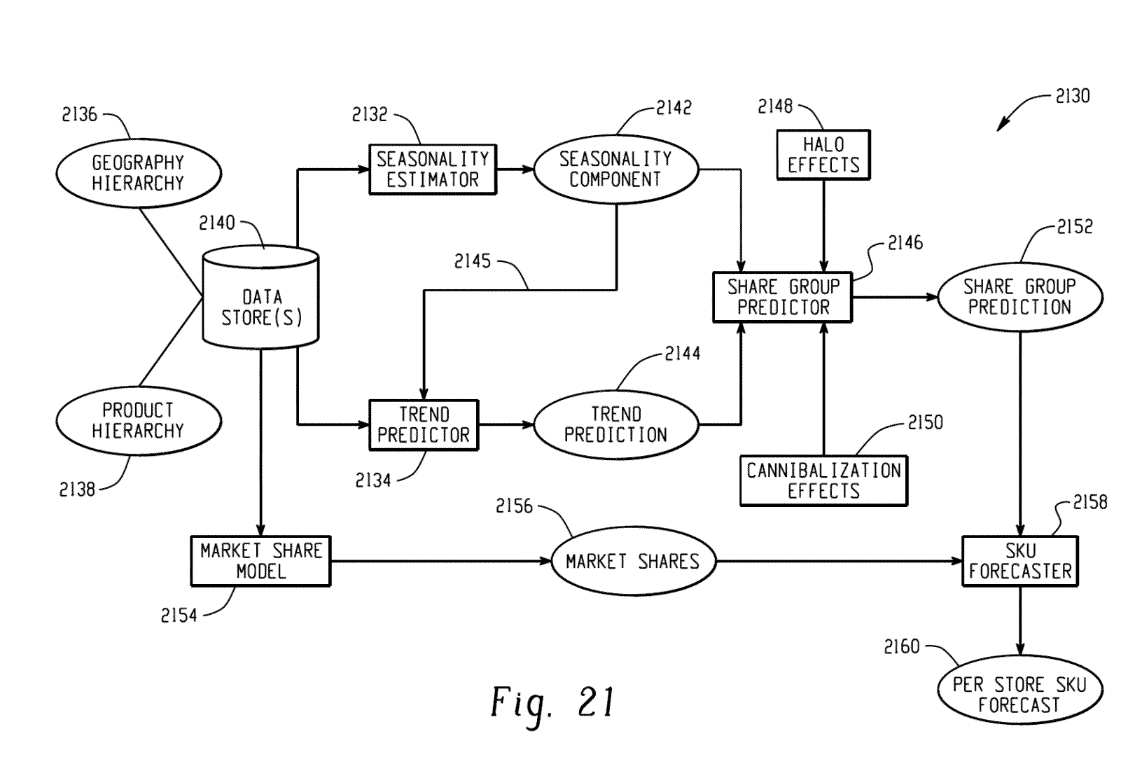

FIG. 21 is a block diagram depicting the integration of secondary effects in the interaction model prediction system. As described above, a cyclical aspect estimator 2132 and a movement predictor 2134 receive spatial hierarchy 2136 and object hierarchy 2138 data from the one or more data stores 2140 to produce a cyclical aspect component 2142 and a movement prediction 2144, respectively. FIG. 21 also illustrates at 2145 that the movement predictor 2134 may receive the generated cyclical aspect component to remove cyclical aspects (e.g., de-seasonalize) of the received data to improve movement predictions. The cyclical aspect component 2142 and the movement prediction 2144 are received by the related object group predictor 2146. The related object group predictor 2146 also receives information related to bias effects 2148 based on charge (i.e., pricing/cost) and publicity in complementary related object groups and output reduction effects 2150 based on charge and publicity in comparable related object groups. For example, the related object group predictor 2146 may increase its related object group prediction 2152 for the salsa related object group based on a bias effect 2148 caused by a charge reduction on chips. As another example, the related object group predictor 2146 may decrease its related object group prediction 2152 for the first beer related object group based on an output reduction effect 2150 caused by a charge reduction on second beers. The related object group predictor 2146 incorporates data from the calculated cyclical aspect component 2142 and movement predictions 2144 as well as any bias effects 2148 and output reduction effects 2150 to generate a related object group prediction 2152 for an entire related object group 2152.

The global output fraction model 2154 also receives spatial hierarchy 2136 and object hierarchy 2138 data from the one or more data stores 2140 to calculate one or more individual global output fractions 2156. The related object group prediction 2152 and the individual global output fractions 2156 are input into an SKU predictor 2158 that multiplies the individual global output fractions 2156 by the prediction for the entire related object group 2152 to calculate a per store SKU prediction 2160.

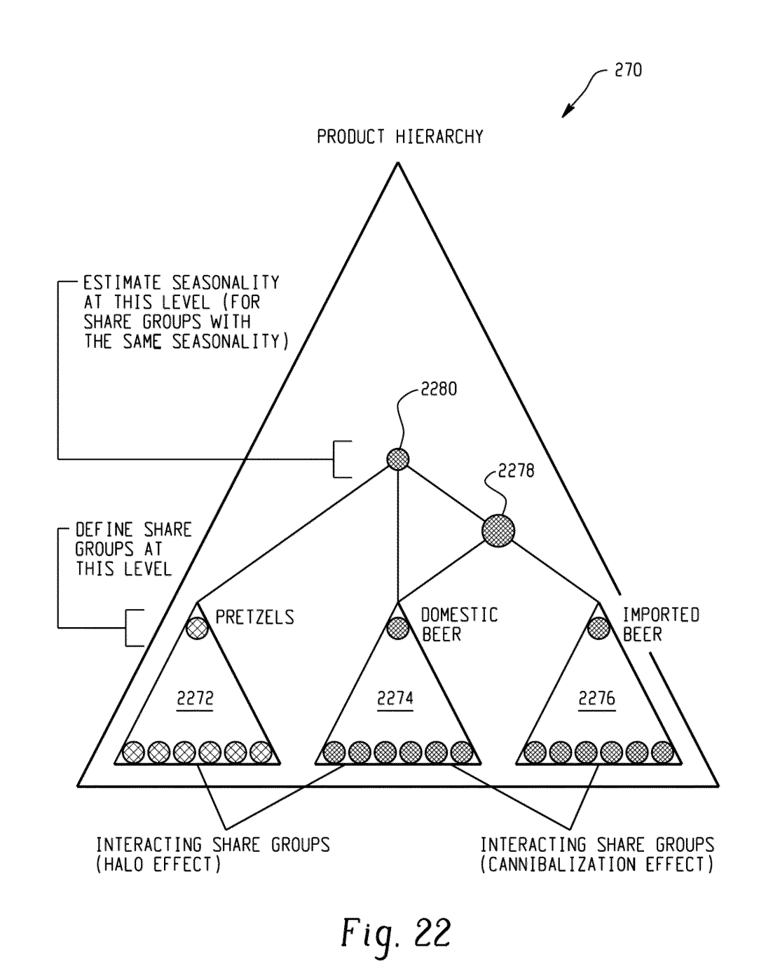

The utilization of hierarchical data structures such as the spatial and object hierarchies offers increased processing speed potential based on pre-aggregations of data in the hierarchical data structures; increased targetability of results through selectability of output prediction levels; and increased flexibility over flat data constructs. FIG. 22 depicts an example of this flexibility through level selection for a cyclical aspect estimation. As noted above, primary effects such as cyclical aspects and movements may be approximated or predicted at different levels of the object and spatial hierarchies. The object hierarchy 2270 includes a number of related object groups that include the pretzels related object group 2272, the first beer related object group 2274, and the second beer related object group 2276. As noted above, cyclical aspects may be approximated at one of several different levels of the object hierarchy 2270. A user may choose to approximate cyclical aspects at a first level 2278 that incorporates both the first beer 2274 and the second beer 2276 related object groups as these groups are likely to have similar cyclical aspects. However, it may be desirable to include other related object groups by estimating cyclical aspects at a higher level 2280. Estimating cyclical aspects at the higher level 2280 includes other related object groups, such as pretzels 2272, that may have similar cyclical aspects. Including other related object groups having similar cyclical aspects may improve predictive results by utilizing a more robust data set. Level selection may also be done by the computer-implemented system.

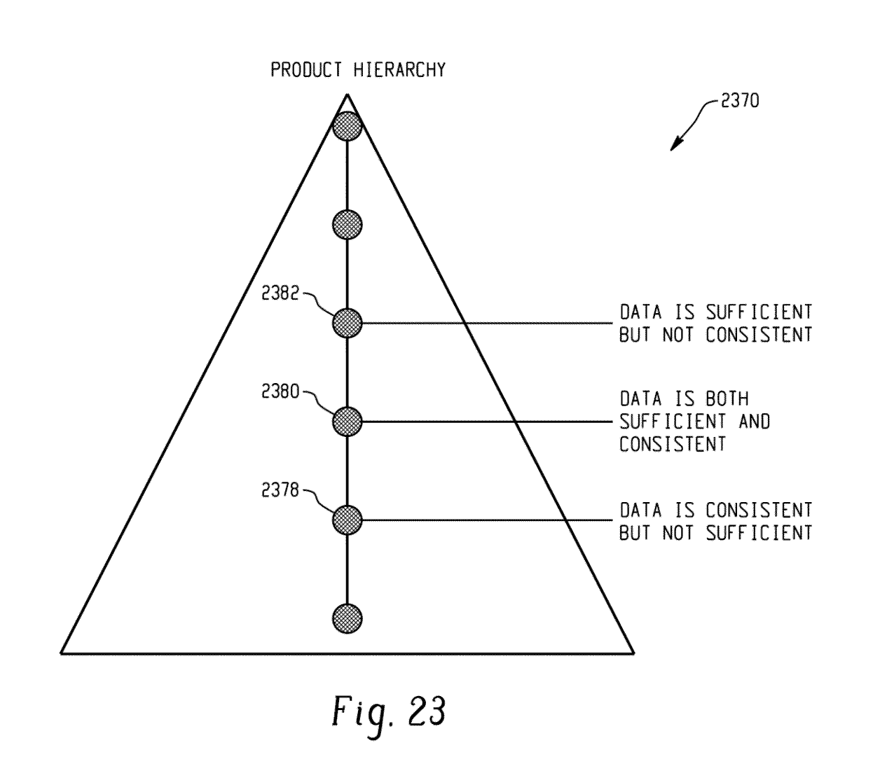

FIG. 23 depicts considerations for spatial level selection for cyclical aspects estimation. At a first level 2378, which corresponds to the level 2278 of FIG. 22 that includes the first beer 2274 and second beer 2276 related object groups, the data may be consistent in that the included related object groups have similar cyclical aspects, but the data may not be sufficient in that other related object groups having similar cyclical aspects may be excluded. The second level 2380 corresponds to the level selected to approximate cyclical aspects in the example of FIG. 22, where the data is consistent in that the captured related object groups have similar cyclical aspects, and the data is sufficient in that other similar related object groups are not excluded. The third level 2382 illustrates a disadvantage in proceeding too high up the hierarchy in selecting a cyclical aspects approximate level, where the data becomes inconsistent. For example, the third level 2382 may further include the chicken soup related object group, which, being a food more likely associated with winter, may have differing cyclical aspects than the pretzel and beer related object groups. Similar level decisions may be made with respect to the spatial hierarchy and movement predictions based on the data sets and analysis needs.

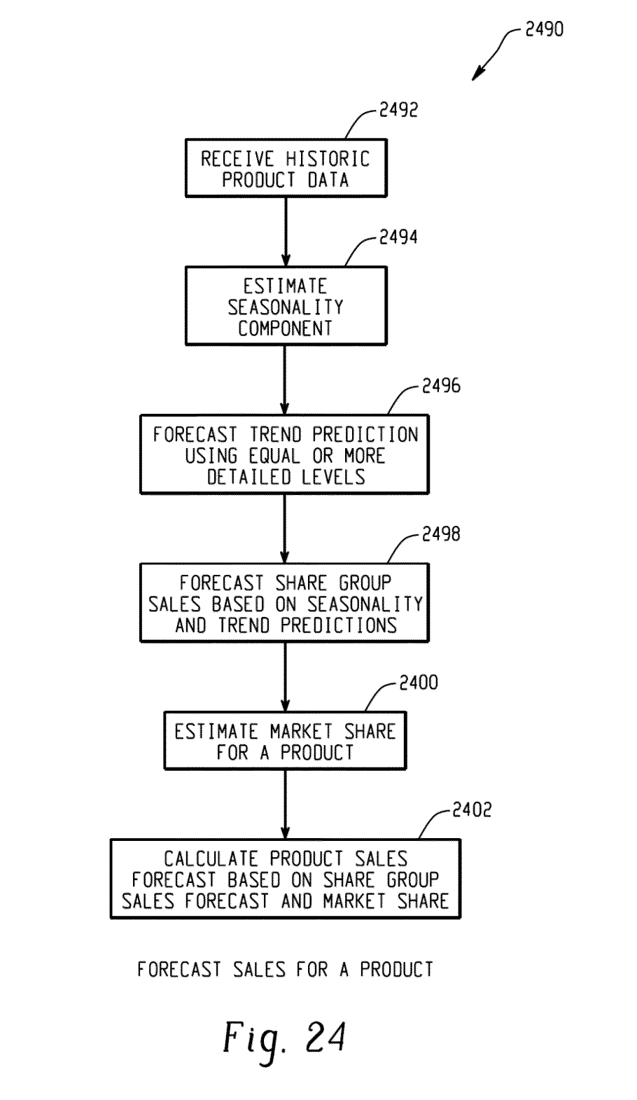

FIG. 24 is a flow diagram illustrating calculation of object output predictions utilizing hierarchical data. Past data is received from a computer-readable data store as shown at 2492. A cyclical aspect component is approximated based upon aggregated data from a first level of the spatial hierarchy and a first level of the object hierarchy as shown at 2494. At 2496, a movement prediction is determined based upon aggregated data from a second level of the spatial hierarchy and a second level of the object hierarchy, where equal or more detailed levels of one or both of the hierarchies are used in determining the movement prediction. Related object group outputs are predicted based on the cyclical aspect component and the movement prediction as illustrated at 2498. A global output fraction is approximated for one or more objects at 2400, and an object output prediction is calculated at 2402 based upon the predicted outputs for a related object group and the approximated object global output fraction.

As an example of implementation of the interaction model output prediction system, reference is made to the beer hierarchy example of FIG. 13. As shown at 1302 and 1304 the related object groups of interest are defined as the first beer related object group 1302 and the second beer related object group 1304. Cyclical aspects may be approximated at a higher level than total requirement. In this example, each subcategory level 1374 shows a distinct cyclical pattern within each climate zone. Both first and second beer show similar cyclical aspects, and each cluster within each climate zone shows a similar cyclical aspect. Therefore, the Climate/Subcategory level is selected for estimation of cyclical aspects. Cyclical aspects may be approximated utilizing the Unobserved Components Model (UCM) with movement (trend), cyclical, and holiday dummies, actual-to-regular charge ratio, and available publicity support (PS) variables. Other possible models include, but are not limited to, ARIMAX, as well as two-step models such as UCM and Winters smoothing methods combined models and ARIMA and Winters smoothing methods combined models.

Total requirement may be approximated at the Metro/Type level, which is below the level where a cyclical aspect is approximated. Within each climate zone, different metros can exhibit different movements (e.g., some metros may grow at a faster rate than others). Thus, total requirement can grow at a different speed in different metros. Similar differences in movement may exist on the object side, where requirement for different types of beverages can grow at different rates. Thus, movements may be approximated at the subcategory level. Movement prediction may use a UCM model with movement, charge ration, and PS variables to get approximates for sensitivity to changes of charge and publicity, as well as an approximate for the movement. The movement predictor may use the results of the cyclical aspect approximate to remove cyclical aspects from the data prior to making a movement prediction.

One or more of the movement prediction, cyclical aspects approximate, sensitivity to changes, and output related variables are combined to obtain output predictions at the Metro/Type level. For a multiplicative model, prediction of total outputs at this level may be calculated by multiplying the movement times the cyclical aspect times the output lift computed from the sensitivity to changes and past and upcoming charges for charge ration and PS variables. The output predictions may then be disaggregated to the Store/Subtype level such that the predictions are of related object group scope. This may be accomplished using past outputs as weights.

Using a global output fraction model, object based fractions and sensitivity to changes may be calculated at the Store/SKU level using an attraction model such as the MCI (Multiplicative-Competitive-Interaction) model or MNL (multinomial-logit) model. The object based fractions and sensitivity to changes may then be used to obtain a predicted global output fraction for each object within a related object group. The related object group total output prediction and the prediction of an object's fraction of the related object group outputs are then multiplied to obtain a prediction of output for an individual object.

While examples have been used to disclose the invention, including the best mode, and also to enable any person skilled in the art to make and use the invention, the patentable scope of the invention is defined by claims, and may include other examples that occur to those skilled in the art. Accordingly, the examples disclosed herein are to be considered non-limiting. As an illustration, many different computer configurations can be used to store hierarchical data for use in requirement prediction analysis. For example, the data may be stored in a hierarchical fashion such that low-level data (e.g., data at an SKU level) may be aggregated to a higher level (e.g., an object type level or metro region level). Summary data can appear at the higher level nodes to describe data of all of the child nodes encapsulated by the higher level node. This aggregation through hierarchical storage may be accomplished using a dedicated multidimensional database such as a MOLAP database implementation, which is specifically tailored for capturing aggregation data and making it readily available for calculations.

It is further noted that the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented by program code comprising program instructions that are executable. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

This written description uses examples to disclose the invention, including the best mode, and also to enable a person skilled in the art to make and use the invention. The patentable scope of the invention may include other examples that occur to those skilled in the art.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other machine-readable media for use by a computer program.

The systems and methods may be provided on many different types of machine-readable media including computer storage mechanisms (e.g., CD-ROM, diskette, RAM, flash memory, computer's hard drive, etc.) that contain instructions for use in execution by a processor to perform the methods' steps and implement the systems described herein.

What is claimed is:

1. A system, comprising:
a network node in data communication with one or more remote nodes, the network node including one or more processors; and
one or more non-transitory computer-readable storage mediums containing instructions configured to cause the one or more processors to perform steps including:
receiving, by the network node, past data stored in a multidimensional online analytical processing database, wherein the past data is organized according to a spatial hierarchy that includes a plurality of levels and an object hierarchy that includes a plurality of levels, wherein each level in each hierarchy includes a corresponding amount of detail, wherein the plurality of levels include one or more related object groups;
evaluating a selection of a level in the spatial hierarchy and a level in the object hierarchy, wherein the selected levels in each hierarchy have a corresponding amount of detail;
generating a cyclical aspect component using past data located at the selected levels in each hierarchy;
evaluating a selection of a different level in the spatial hierarchy and a different level in the object hierarchy, wherein the different levels in each hierarchy have a greater corresponding amount of detail;
generating a movement component using past data located at the different levels in each hierarchy;
generating a base requirement component for a related object group in the plurality of levels using the cyclical aspect component and the movement component;
generating an individual approximated global output fraction for a member of a related object group using the past object data and a global output fraction model, wherein the individual approximated global output fraction is a proportion of total outputs for the related object group expected for a particular object; and
predicting approximated output for the particular object using the base requirement component and the individual approximated global output fraction for the particular object, wherein predicting includes multiplying the base requirement component by the individual approximated global output fraction.
